(19) United States
(12) Patent Application Publication
(10) Pub. No.: US 2004/0003695 A1
(43) Pub. Date: Jan. 8, 2004

(54) Paper cutting and apparatus and method

(76) Inventors: Norman Diamond, Deerfield, IL (US); Nikola I. Konsulov, Des Plaines, IL (US)

Correspondence Address: BAKER & HOSTETLER LLP, Washington Square, Suite 1100, 1050 Connecticut Avenue, N.W., WASHINGTON, DC, 20036, US

(21) Appl. No.: 10/413,585

(22) Filed: Apr. 15, 2003

Related U.S. Application Data
(60) Provisional application No. 60/372,801, filed on Apr. 17, 2002.

(51) Int. Cl. B26D 7/06

(52) U.S. Cl. 83/56; 83/436.3

(57) ABSTRACT

A device and method cuts paper from a supply such as a paper roll into predetermined lengths, and supplies these cut tickets or cards to a ticket processing device. The device includes a paper supply holder, a paper guide, a paper feeder, and a paper cutter. The device can be attached to a conventional ticket processing device.

### PRIORITY

This application claims priority to the provisional U.S. patent application entitled, AUTOMATIC PAPER CUTTER FOR TICKET MACHINES, filed Apr. 17, 2002, having a serial No. 60/372,801, the disclosure of which is hereby incorporated by reference.

### FIELD OF THE INVENTION

The present invention relates generally to processing a paper roll into a ticket or card for a ticket machine. More particularly, the present invention relates to a device for automatically feeding and cutting a paper roll into preprocessed tickets or cards for a ticket processing device.

### BACKGROUND OF THE INVENTION

Automatic ticket preparation systems are typically utilized, for example, on modern mass transit systems. These systems often provide their riders with a variety of options with respect to the type of ticket to be purchased by the rider. Tickets have typically been printed and encoded from preprocessed cards which have a heat sensitive coating (to respond to a thermal dot matrix printer) and a linear strip of magnetic sensitive material (capable of responding to a magnetic field to become magnetically encoded).

The use of preprocessed cards has been made more practical by the provision of a cartridge for the cards. The cards are commonly stacked in the cartridge and sealed at a remote facility. The sealed cartridge is transported to the ticket processing device in which it is to be used. Thus the cards are handled in fixed groups, rather than in bulk, minimizing the likelihood of theft of the cards for the purpose of producing forged tickets. After the cartridge is placed in the ticket processing device, the ticket processing device removes the cards one at a time in sequence from the cartridge for the purpose of originating a ticket.

An operator may be provided with a control keyboard and a display located on the ticket processing device. The supporting electronics of the ticket processing device permit the operator to print and encode tickets for values equal to, for example, certain dollar values, multiple rides, a single ride, or a ride and a transfer.

This manner of providing preprocessed cards to the ticket processing device is limited by the amount of preprocessed tickets that are available within the sealed cartridge. Further, the entire cartridge must be changed when empty. In addition, a large effort may be needed to obtain the preprocessed tickets, properly package them in a cartridge, and deliver them to the ticket processing device.

A need exists, therefore, for providing the automated generation and delivery of a large supply of tickets directly to a ticket processing device. A need further exists for a technology to provide protection against forged tickets while generating the tickets. Finally, a need exists to directly supply tickets to currently deployed ticket processing devices already in use.

### SUMMARY OF THE INVENTION

It is therefore a feature and advantage of the present invention to provide the automated generation and delivery of a large supply of tickets directly to a ticket processing device.

It is another feature and advantage of the present invention to provide protection against forged tickets while generating the tickets.

It is another feature and advantage of the present invention to directly supply tickets to currently deployed ticket processing devices already in use.

The above and other features and advantages are achieved through the use of a novel apparatus and method as herein disclosed. In accordance with one embodiment of the present invention, an automatic paper cutter device is provided for feeding cut lengths of paper from a paper roll to a ticket processing device. The automatic paper cutter device includes a paper roll frame assembly having a paper roll support and a paper feed guide assembly. The device also provides a pair of pinch rollers, and a paper cutter device.

In another aspect of the invention, an automatic paper cutter system is provided for feeding cut lengths of paper for a paper roll to a ticket processing device. The system includes a means for supporting the paper roll and a means for advancing the paper from the paper roll. Additionally, the system may also include a means for guiding the advancing paper from the paper roll and a means for cutting the advancing paper.

In another aspect of the invention a method of preprocessing tickets or cards is provided including feeding paper from a paper source and guiding the paper to a cutter. The method also provides cutting the paper into predetermined lengths.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a side view illustrating a paper roll frame assembly connected to a ticket receipt issue machine (TRIM) assembly according to a preferred embodiment of the present invention.

FIG. 2 is a perspective view of the TRIM frame subassembly.

FIG. 3 is a side view of the paper roll frame assembly.

FIG. 4 is a cross-sectional view taken along line 4-4 of FIG. 3.

FIG. 5 is a cross-sectional view taken along line 5-5 of FIG. 3.

FIG. 6 is a side layout view of the paper roll frame assembly connected to the TRIM assembly.

FIG. 7 is a perspective view illustrating alternative embodiment of a paper roll frame assembly.

FIG. 8 is a view of the components shown in the paper roll fram assembly of FIG. 7.

### DETAILED DESCRIPTION OF THE INVENTION

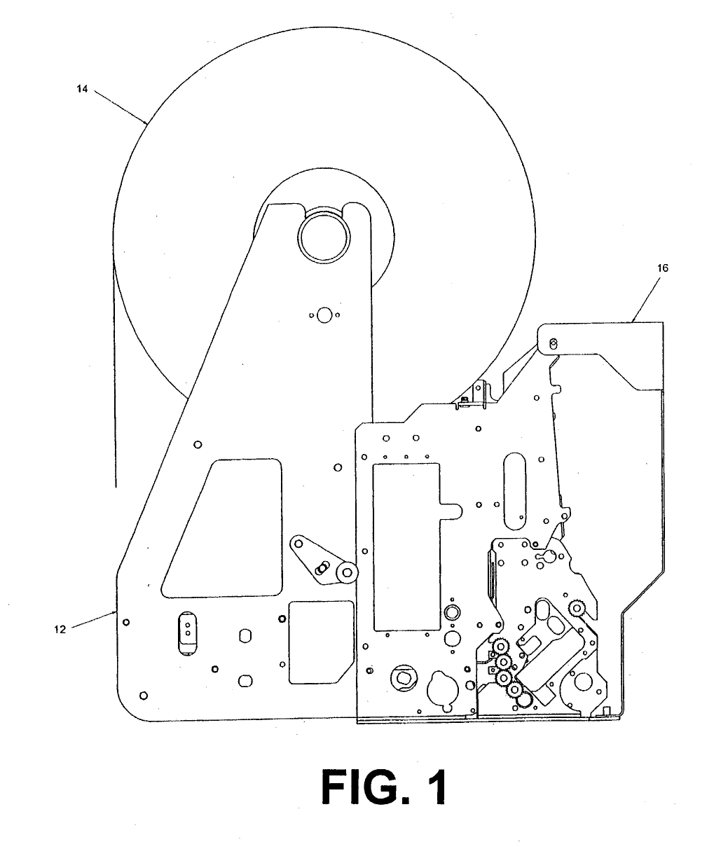

The present invention provides an automatic paper cutter which can be connected to ticket processing device such as, for example, a device known as a ticket receipt issue machine (TRIM). A preferred embodiment of the present invention will now be described with reference to the drawing figures, in which like reference numbers refer to like elements throughout. Referring to FIG. 1, an automatic paper cutter assembly 10 includes a paper roll frame assembly 12 which may be utilized to perform a variety of functions as will be further described herein. The paper roll frame assembly 12 is further designed to connect with the TRIM 16 in order to provide preprocessed tickets or cards directly to the TRIM 16.

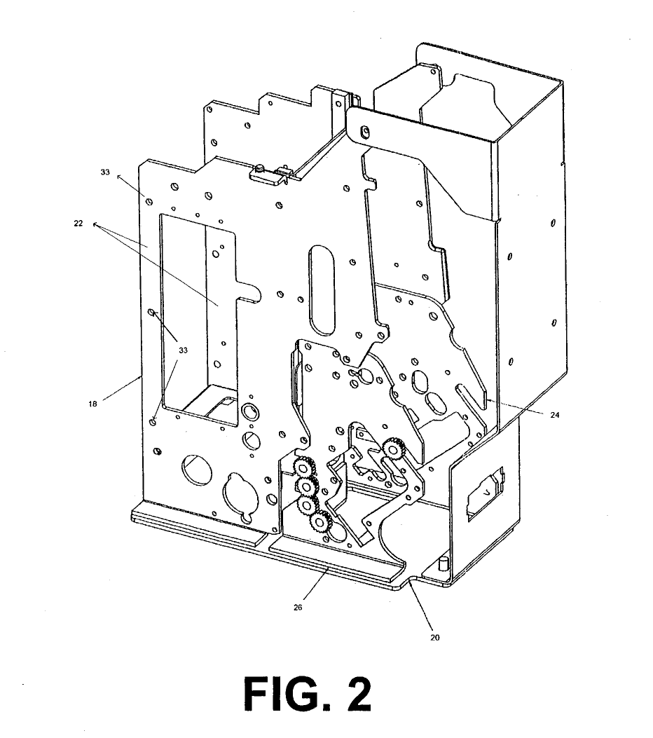

FIG. 2 illustrates additional components of the TRIM 16 which has a TRIM frame subassembly 18. The TRIM 16 rests via platform 20 of the TRIM frame subassembly 18 which provides stability to the TRIM subassembly structure. The TRIM frame subassembly 18 may incorporate attachment edges 22 to provide the structure to which the paper roll frame assembly 12 is connected.

A right printer side plate 24 and a left printer side plate 26 may be incorporated into the TRIM frame subassembly 18. The right printer side plate 24 and the left printer side plate 26 can be utilized to support and retain printers used to print or encode information onto the already-cut tickets as they pass through the TRIM assembly 16. The TRIM frame subassembly 18 is further capable of supporting additional components used to process tickets or cards. These may include, for example, pinch rollers for advancing tickets or cards, and/or magnetic heads for encoding and decoding information onto tickets or cards.

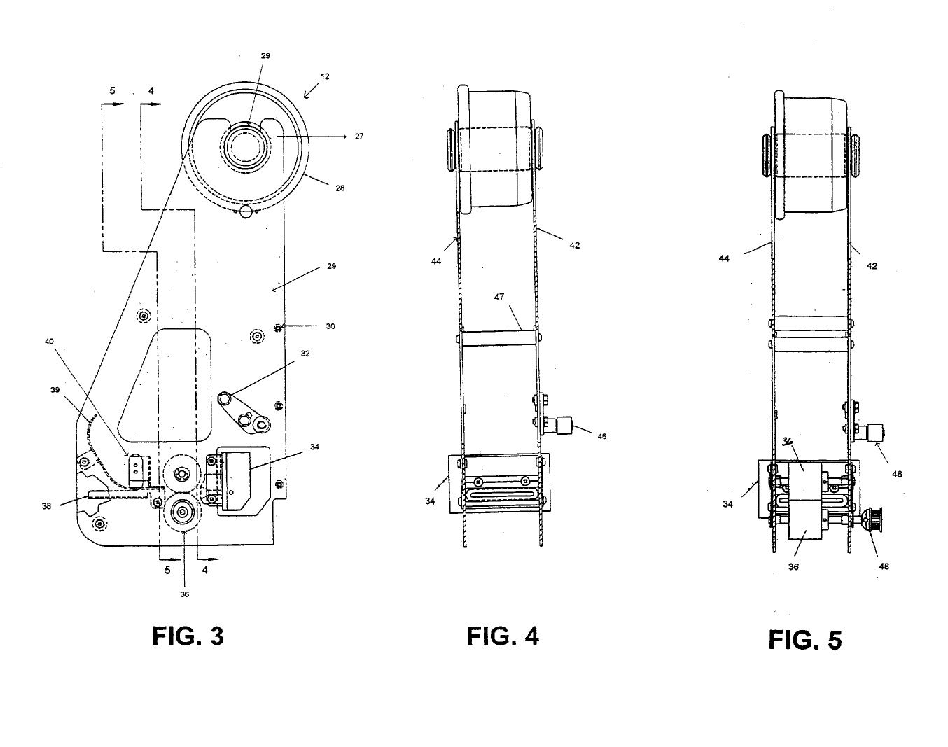

FIG. 3 provides a more detailed view of the paper roll frame assembly 12 and its various components in a preferred embodiment of the present invention. The paper roll frame assembly 12 includes a support area 27 to retain the paper roll 28. The support area 27 preferably is configured with a U-shaped saddle in order to support a shaft 29 that supports the paper roll 28. The paper roll 28 may be a roll of thermally coated paper suitable for further processing such as by a printer containing a thermal unit located within the TRIM assembly 16.

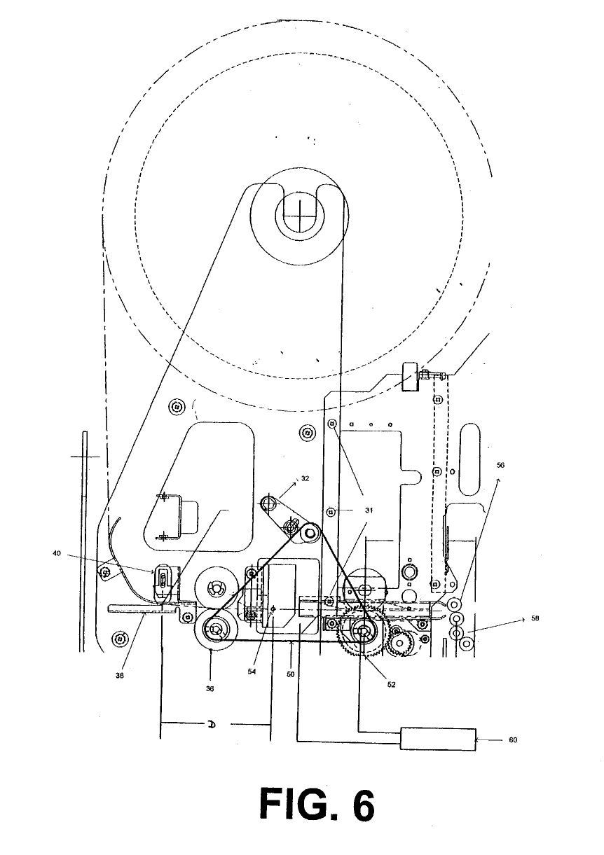

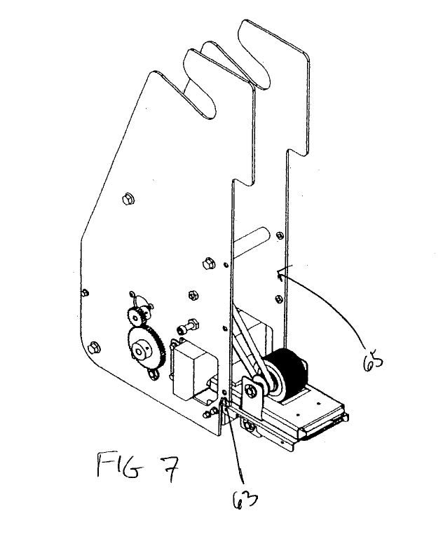

In order to connect the paper roll frame assembly 12 to the TRIM assembly 16, attachment holes 30 may be provided to receive a retaining means. Such a retaining means may include, for example, a screw and nut assembly 31 along an attachment edge portion 29 of the paper roll frame assembly 12, as seen in FIG. 6. The attachment holes 30 of the paper roll frame assembly 12 can be aligned with corresponding holes 33 formed in the attachment edge 22 of the TRIM frame subassembly 18. The retaining means 31 can then be utilized to secure the paper roll frame assembly 12 to the attachment edge 22 of the TRIM frame subassembly 18, as seen in FIG. 6.

Another function of the paper roll frame assembly 12 may include providing a support structure to which additional paper processing components may be attached. As shown in FIG. 4, such additional components may be secured directly to the paper roll frame assembly 12. These components may include an idler take-up device 32, a rotary cutter device 34, ticket pinch rollers 36, a paper feed guide assembly 38, and an optical sensor device 40. The rotary cutter device 34, for example, may be connected to the paper roll frame assembly 12 and secured thereto via a securing means such as a screw and washer assembly.

In a preferred configuration, the paper roll 28 is spooled toward the rotary cutter device 34 along a pathway through a paper feed guide assembly 38. The paper feed guide assembly 38 acts to provide a slight tension to the paper as it is spooled off the paper roll. In addition, the paper feed guide 38 directs the paper along a travel path towards the rotary cutter device 34. Part of the paper feed guide assembly 38 may include a curved guide plate 39 preferably designed in a generally C-shaped configuration. This design allows for the varying angle of the paper feed as it is spooled from the paper roll 28, and provides a small frictional resistance with the moving paper against the take-up feeding force.

In a preferred embodiment of the invention, an optical sensor device 40 is placed along the paper feed pathway to detect whether paper is present for feeding into the rotary cutter device 34. Pinch rollers 36 assist in transferring the paper feed from the paper roll 28 toward the rotary cutter device 34. It will be appreciated that the pinch rollers 36 can operate in combination with a belt 50 in connection with the idler take-up device 32 and the various components of the TRIM assembly 16 during the advancement of the paper roll and the cutting procedure performed by the rotary cutter device 34. The idler take-up device 32 may be secured to the paper roll frame assembly 12, for example, by a hex screw and nut assembly. The idler take-up device 32 is adjustable in order to adjust the tension of a drive belt 50.

FIG. 4 shows a cross-sectional view taken along section line 44 of FIG. 3. A right support plate 42 and left support plate 44 act not only to support the paper roll 28 and the rotary cutter 34, but to serve as support structures to which additional components may be attached. The right support plate 42 and left support plate 44 may be comprised of a material, such as aluminum, which is relatively lightweight, yet also sufficient to provide strength to the overall design of the plate structure. A spacer 47 may be provided for additional support to the overall structure of the paper roll frame assembly 12. The belt tensioner 46 extends from the idler take up device 32 and is utilized during the operation of spooling the paper from the paper roll 28 as further described below.

FIG. 5 shows an additional cross-sectional view taken along line 5-5 of FIG. 3. A tooth pulley 48 extends from the ticket pinch rollers 36 and is also utilized for spooling the paper from the paper roll 28.

Returning to FIG. 4, the paper roll frame assembly 12 is connected to the TRIM assembly 16. This configuration demonstrates how the now-cut tickets or cards can be produced and directly supplied to the TRIM assembly 16. Preferably the TRIM assembly receives these cards in condition similar to preprocessed cards from a cartridge. Thus, the TRIM assembly 16 can be retrofit for operation from a cartridge system to an automatic paper cutter assembly 10. As shown, the paper roll frame assembly 12 is preferably attached along the attachment edge 22. A drive belt 50 runs over pinch rollers 52, the belt tensioner 46 of the idler take-up device 32 and the ticket pinch rollers 36. The drive belt 50 thus couples the pinch rollers 52 of the TRIM assembly 16 to cooperate with the pinch rollers 36 of the paper roll frame assembly 12 during the advancement of the paper roll 28 and hence advancement of the now-cut tickets.

In operation, the ticket pinch rollers 36 feed paper down the paper roll 28 along the paper feed guide 38. The optical sensor device 40 can be utilized to detect the presence of paper fed from the paper roll 28. The paper is next fed to the rotary cutter device 34 which is used to cut the paper roll 28 at predetermined lengths to form a ticket or card. Once a ticket or card is cut from the paper roll 28, pinch rollers 52 are used to hold the ticket or card in escrow. The ticket or card can be delivered to the processing area of the TRIM assembly 16 through pinch rollers 56 and 58 for subsequent processing operations. A controller 60 shown schematically in FIG. 4, is preferably utilized to control the driving of the rollers 52, 56, 58 and the rotary cutter device 34. The controller 60 can be programmed, for example, to cut tickets of one or more predetermined lengths. FIG. 6 shows that a distance D is present between the optical sensor 40 and the cutting point 54 of the rotary cutter device 34. In cases where the desired length of the ticket is greater than distance D, then the detection of paper at the optical sensor 40 indicates sufficient paper to form a ticket and this information can be transmitted to the controller 60.

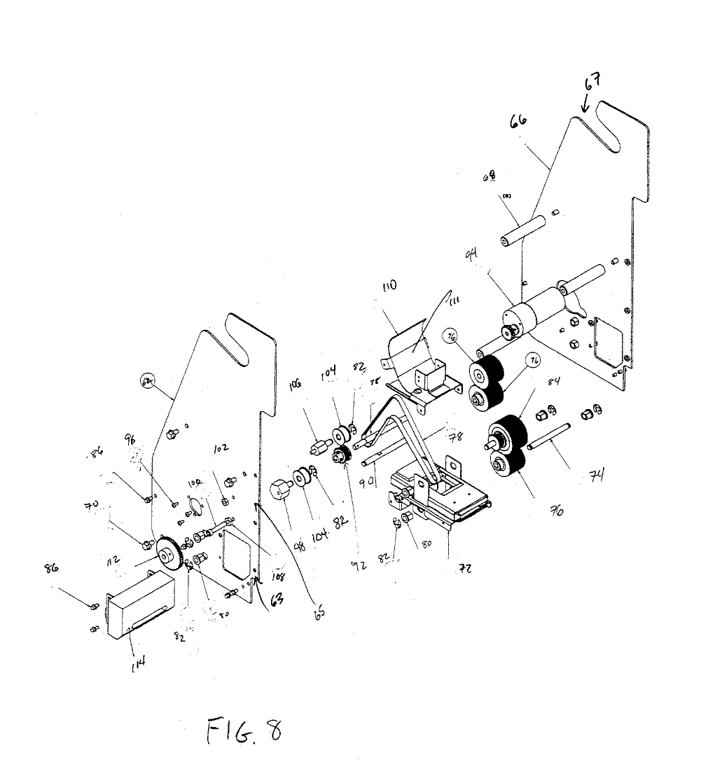

FIG. 7 illustrates an alternative embodiment of the present invention. The alternative embodiment includes a stand alone paper roll frame assembly 62 which is capable of operating as a self-sustained device by advancing paper from a roll, guiding the roll paper, cutting the roll paper for delivery to another device requiring preprocessed tickets or cards provided by the paper roll frame assembly 62. It can be appreciated that a TRIM 16 may be used in conjunction with the paper roll frame assembly 62. However, the paper roll frame assembly 62 may not be limited solely to the use of a TRIM 16 device. The paper roll frame assembly 62 may also be utilized with a plurality of other devices requiring preprocessed tickets or cards provided by the paper roll frame assembly 62.

The embodiment shown in FIG. 7 is a self contained cutter and paper feed unit which does not require any components from another mechanism, such as a TRIM 16, in order to fully operate. This is due, in part, to the unique design of the paper roll assembly and the ability to contain the essential components for advancing the paper and cutting it into precut tickets all within a single unit.

In order to connect the paper roll frame assembly 62 to another device, such as a TRIM assembly 16, attachment holes 63 may be provided to receive a retaining means. Such a retaining means may include, for example, a screw and nut assembly 31 along an attachment edge portion 65 of the paper roll frame assembly 62, as seen in FIG. 7. The attachment holes 63 of the paper roll frame assembly 62 can be aligned with corresponding holes formed in the attachment edge of another frame subassembly which would require preprocessed tickets or cards provided by the paper roll frame assembly 62. The retaining means 31 can be utilized to secure the paper roll frame assembly 62 to an attachment edge of another frame subassembly.

Another function of the paper roll frame assembly 62 may include providing a support structure to which additional paper processing components may be attached. As shown in FIG. 8, such additional components may be secured directly to the paper roll frame assembly 12. These components may include a rotary cutter device 114, ticket drive rollers 76, ticket drive roller assembly 84, a ticket guide bracket 72, a drive motor and gear assembly 94, optical sensor device 40, and a ticket feed guide 110. The rotary cutter device 114, for example, may be connected to the paper roll frame assembly 62 and secured thereto via a securing means such as a screw and washer assembly 82.

In a preferred configuration, the paper roll 28 is spooled toward the rotary cutter device 114 along a pathway through a ticket feed guide 110. The ticket feed guide 110 acts to provide a slight tension to the paper as it is spooled off the paper roll. In addition, the ticket feed guide 110 directs the paper along a travel path towards the rotary cutter device 114. Part of the ticket feed guide 110 may include a curved guide plate 111 preferably designed in a generally C-shaped configuration. This design allows for the varying angle of the paper feed as it is spooled from the paper roll 28, and provides a small frictional resistance with the moving paper against the take-up feeding force.

In a preferred embodiment of the invention, an optical sensor device 40 is placed along the paper feed pathway to detect whether paper is present for feeding into the rotary cutter device 34. Ticket drive rollers 76 and the ticket drive roller assembly 84 assist in transferring the paper feed from the paper roll 28 toward the rotary cutter device 114. It will be appreciated that the ticket drive rollers 76 and the ticket drive roller assembly 84 can operate in combination with a belt 78 in connection with the drive motor 94 during the advancement of the paper roll and the cutting procedure performed by the rotary cutter device 114.

Referring, again to FIG. 8., right support plate 64 and left support plate 66 act not only to support the paper roll 28 and the rotary cutter 114, but to serve as support structures to which additional components may be attached. The right support plate 64 and left support plate 66 may be comprised of a material, such as aluminum, which is relatively lightweight, yet also sufficient to provide strength to the overall design of the plate structure. A spacer 68 may be provided for additional support to the overall structure of the paper roll frame assembly 62. Groove pulley 92 and idler pulley 104 are coupled to drive shafts 90 and 88, respectively. An idler post 106 may be further connected to the idler pulley 104. Drive shafts 88, 90 facilitate the operation of the ticket drive rollers 76 during the operation of spooling the paper from the paper roll 28 as further described below.

In operation, the ticket drive rollers 76 and the ticket drive roller assembly 84 feed paper down the paper roll 28 along the ticket feed guide 110. The optical sensor device 40 can be utilized to detect the presence of paper fed from the paper roll 28. The paper is next fed to the rotary cutter device 114 which is used to cut the paper roll 28 at predetermined lengths to form a ticket or card. Once a ticket or card is cut from the paper roll 28, the ticket drive roller assembly 84 is used to hold the ticket or card in escrow. The ticket or card can be delivered to the processing area of another device requiring preprocessed tickets or cards and possibly for subsequent processing operations. A controller is preferably utilized to control the drive motor and gear assembly 94, ticket drive rollers 76 and the ticket drive roller assembly 84. The controller can be programmed, for example, to cut tickets of one or more predetermined lengths.

It is further appreciated the ticket rollers 76 and the rollers of the ticket drive roller assembly 84, comprise a one-way clutch assembly to prevent the rollers from spinning back upon themselves. This feature works to maintain tautness in the paper feed. Additionally the roller design includes a capability to detect variances in the tautness of the paper roll feed and to adjust the take-up speed in the rollers in order to prevent the paper roll 28 from spinning or unraveling uncontrollably. This design essentially eliminates the need to provide a braking mechanism coupled to the paper roll to adjust the paper web feed.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed:

1. An automatic paper cutter device for feeding cut lengths of paper from a paper roll to a ticket processing device, comprising:
a paper roll frame assembly having a paper roll support and a paper feed guide assembly;
a pair of pinch rollers that feed paper from the paper roll; and
a paper cutter device that cuts the fed paper into predetermined lengths.

2. The device of claim 1, further comprising:
an optical sensor device that determines whether paper is present along a paper feed pathway between the paper roll and the paper cutter.

3. The device of claim 1, wherein the paper feed guide assembly further comprises:
a curved guide plate.

4. The device of claim 1, further comprising an attachment portion that attaches to the ticket processing device.

5. The device of claim 4, further comprising a plurality of attachment holes located on the attachment edge.

6. The device of claim 1, further comprising a pulley connected to rotate with the pair of pinch rollers.

7. The device of claim 1, wherein the paper roll support further comprises:
a first plate support; and
a second plate support.

8. An automatic paper cutter system for feeding cut lengths of paper for a paper roll to a ticket processing device, comprising:
means for supporting the paper roll;
means for advancing the paper from the paper roll;
means for guiding the advancing paper from the paper roll; and
means for cutting the advancing paper into predetermined lengths.

9. The system of claim 8, further comprising means for detecting whether paper is present along a paper feed pathway between the paper roll and the cutting means.

10. The system of claim 8, further comprising means for attaching the paper roll frame system to the ticket processing device.

11. The system of claim 9, wherein the paper detecting means comprises an optical sensor device.

12. The system of claim 10, wherein the attaching means comprises an attachment edge having attachment holes located therein.

13. The system of claim 8, wherein the supporting means comprises:
a first plate support; and
a second plate support.

14. The system of claim 8, wherein the paper guiding means comprises a paper feed guide assembly.

15. The system of claim 8, wherein the paper advancing means comprises a pair of pinch rollers;

16. The system of claim 15, wherein the pinch rollers are coupled to the ticket processing device.

17. A method of preprocessing tickets or cards from a paper source for use by a ticket processing device comprising the steps of:
feeding paper from the paper source;
guiding the paper to a cutter; and
cutting the paper into predetermined lengths for delivery to a ticket processing device.

18. The method of claim 17, further comprising delivering the cut paper to the ticket processing device.

19. The method of claim 17, wherein the feeding, guiding, cutting, and supplying steps are automated.

20. The method of claim 17, further comprising:
detecting if a necessary length of paper is available to be cut.

21. The method of claim 20, wherein the detecting step is automated.

22. The method of claim 21, wherein the detecting step is performed by an optical sensor device.

23. The method of claim 17, further comprising feeding the paper via a pair of pinch rollers.

24. The method of claim 23, further comprising coupling the pinch rollers to the ticket processing device.

25. The device of claim 1, wherein the pinch rollers include a one-way clutch mechanism.

26. The system of claim 15, wherein the pinch rollers include a one-way clutch mechanism.

27. The method of claim 17, further comprising adjusting a take-up speed of the rollers in accordance with the paper roll feed.
